(19) United States
(12) Patent Application Publication
(10) Pub. No.: US 2003/0187667 A1
(43) Pub. Date: Oct. 2, 2003

(54) CyberXpert companion suite of products

(76) Inventor: Sayed Aziz Azimi, Falls Church, VA (US)

Correspondence Address: Sayed Aziz Azimi, Suite 302, 450 West Broad Street, Falls Church, VA, 22046, US

(21) Appl. No.: 10/112,361

(22) Filed: Apr. 1, 2002

(51) Int. Cl. G06F 17/60

(52) U.S. Cl. 705/1

(57) ABSTRACT

The CyberXpert Companion Suite of Products is an interactive multimedia method and system for providing customers with real-time information on a variety of products and services. This interactive, game-like electronic tool applies the simulated artificial intelligence model™ to serve multiple audiences via a new concept in marketing and E-commerce: the “business-to-business-to-business single-product concept” (B2B2B). B2B2B goes beyond the business-to-business (B2B) concept, which has fallen short of expectations. This invention involves industry- and audience-specific tools that are the backbone of B2B2B. This process resolves the interests of all parties involved in a mutually beneficial manner that provides a very specific and unique utility for each participant and potentially revitalizes the faltering B2B industry. Traditional retail and E-commerce distributors are not utilized in this unique process.

### TITLE OF THE INVENTION

This invention is entitled the CyberXpert Companion Suite of Products. This invention relates to an interactive multimedia method and system for providing customers with real-time information on a variety of products and services.

### CROSS-REFERENCE TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

The present invention relates to an interactive software system that applies electronic media to providing information to customers through their personal computers. The present invention stimulates fusion between cause and effect into an integrated package that dramatically affects what customers think and do. The present invention facilitates instant comprehension, drives interaction, and provides access to knowledge at critical decision points in a proprietary process referred to as the simulated artificial intelligence model™ (SAIM). The requisite expert knowledge transfer process embodied in this model is a subliminal guide that translates into a unique utility for the end user. It simultaneously removes barriers and leads the customer to make informed choices. The present invention integrates information needed to simultaneously create awareness, interest, desire, and action into a single source focused on product selection, operation, and maintenance. Its interactive, game-like design is based on a three-click strategy; that is, the customer is never more than three clicks away from the desired information. This invention combines features such as three-dimensional modeling, streaming simulation animation, and a parent-child interface for QuickClicks™.

This invention is designed to provide customers with real-time, multimedia information on a variety of products and services. The present invention moves customers toward one-stop access to key products and services, and improves the quality and efficiency of service delivery. Using a personal computer, the customer uses the present invention to arrive at educated purchasing decisions on building equipment, materials and components, appliances, landscaping, and related items. Many existing tools provide information in a static format, which typically fails to reflect modifications or adjustments. Based on an entirely new concept in marketing and E-commerce, this customer-friendly tool replaces the static format with a dynamic, interactive approach designed to inform and influence customers during the decision-making process.

### SUMMARY OF THE INVENTION

The CyberXpert Companion Suite of Products is a software invention that provides a novel and improved interactive system designed to transfer knowledge, influence behavior, and affect customer product selection, operation, maintenance, and financing. This interactive, game-like electronic tool is designed to provide customers with comprehensive information about purchasing and servicing home building equipment, materials and components, appliances, landscaping, and other home-related items. This invention is distributed on a CD-ROM, a portable mass data storage medium.

By applying Technologists, Inc. (TI) simulated artificial intelligence model™ (SAIM), the CyberXpert Companion Suite of Products serves multiple key audiences via an entirely new concept in marketing and E-commerce that we are calling the “business to business to business single-product concept” (B2B2B). B2B2B is a unique combination creating a synergy where the total information and utility result in benefits for each entity. Further, the customer is greater than the sum of the parts. The end user is provided with real-life solutions, simpler navigation, greater access to information, an array of resources previously not integrated, and a variety of time-saving features.

Using the present invention, the customer can evaluate a variety of customer products. This invention integrates information necessary to simultaneously create awareness, interest, desire, and action into a single source focused on product selection, operation, and maintenance. Its interactive, game-like design is based on a three-click strategy; that is, the customer is never more than three clicks away from the desired information. Providing deep links into a large number of web sites enhances this invention's utility. Deep links are critical to getting customers to their preferred destination as quickly as possible. A unique product rating system assists customers choose products based on performance, convenience, and resource conservation. Its interactive, game-like design combines features such as three-dimensional modeling, streaming simulation animation, and a parent-child interface for QuickClicks™.

Therefore, from the foregoing, it is the general object of the present invention to provide a novel and improved system designed to transfer knowledge, influence behavior, and affect customer decision-making in product selection, operation, maintenance, and financing. This interactive invention is designed to provide customers with a convenient, customer-friendly approach to gathering information about purchasing and servicing home building equipment, materials and components, appliances, landscaping, and other home-related items. The present invention reduces the time needed to make better—that is, more informed—decisions.

### BRIEF DESCRIPTION OF THE DRAWINGS

FIG. 1 is an illustration of the elements of the invention, using personal computer architecture and a CD-ROM drive to enable customer use of the invention.

FIG. 2 is an illustration of the processes within the invention.

FIG. 3 is an illustration of the unique utilities built into the invention.

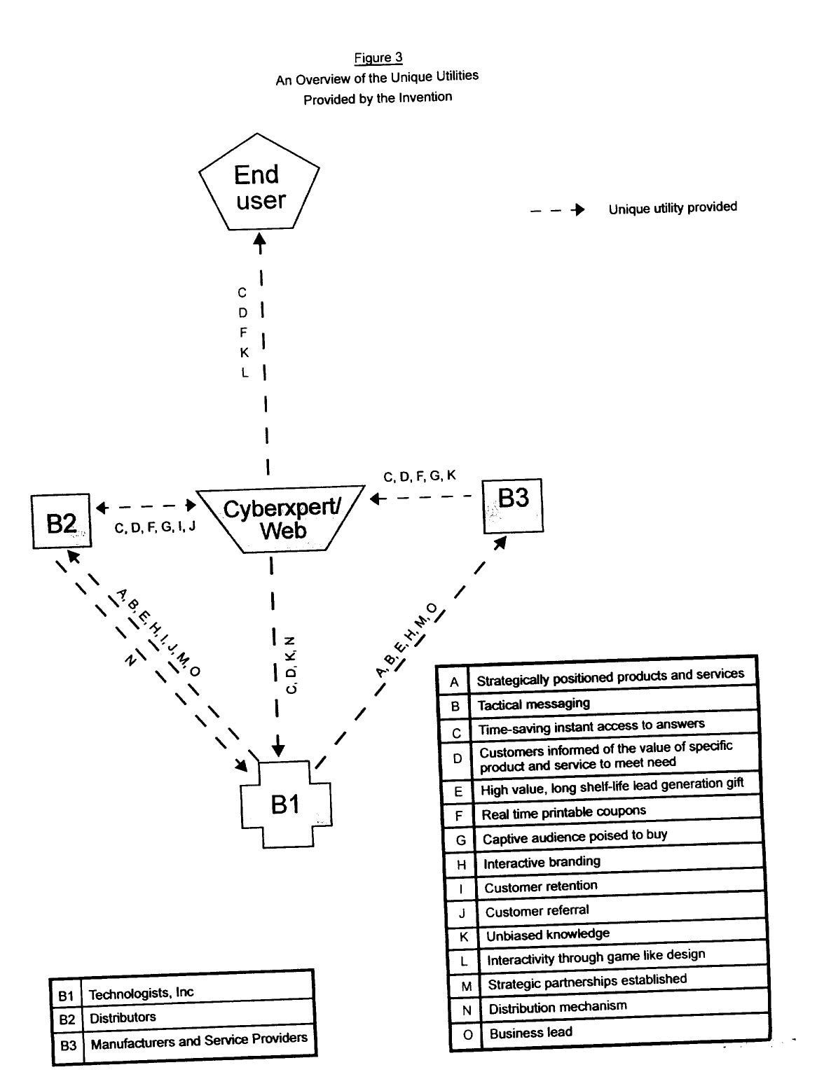

FIG. 4 is a flow chart illustrating the use of the invention according to the preferred embodiments.

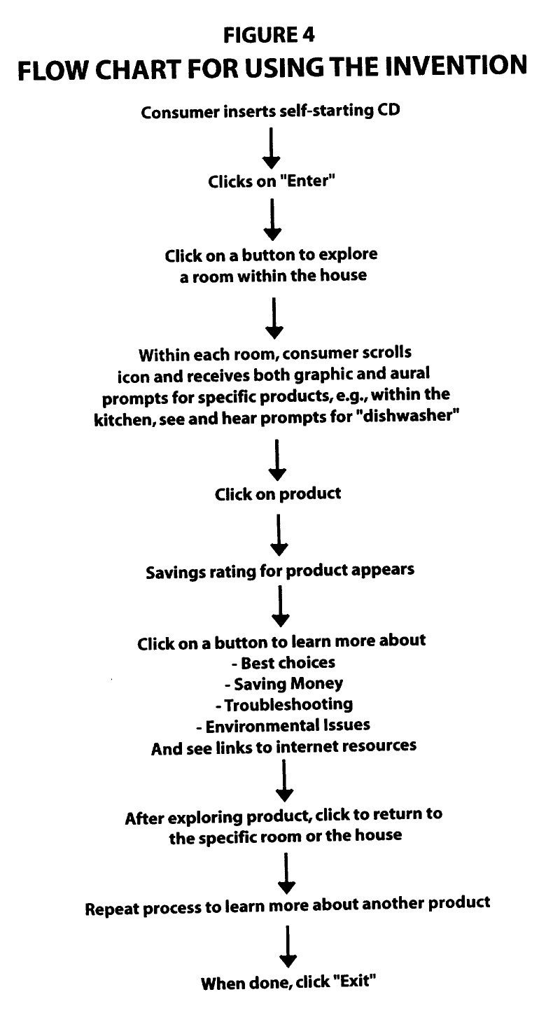

### DETAILED DESCRIPTION OF THE PREFERRED EMBODIMENTS

The following are detailed descriptions of the preferred embodiments. Please note, however, that this invention may be embodied in various forms. Therefore, specific details disclosed herein are not to be interpreted as limiting, but rather as a basis for the claims and as a representative basis for teaching a customer to employ the tool.

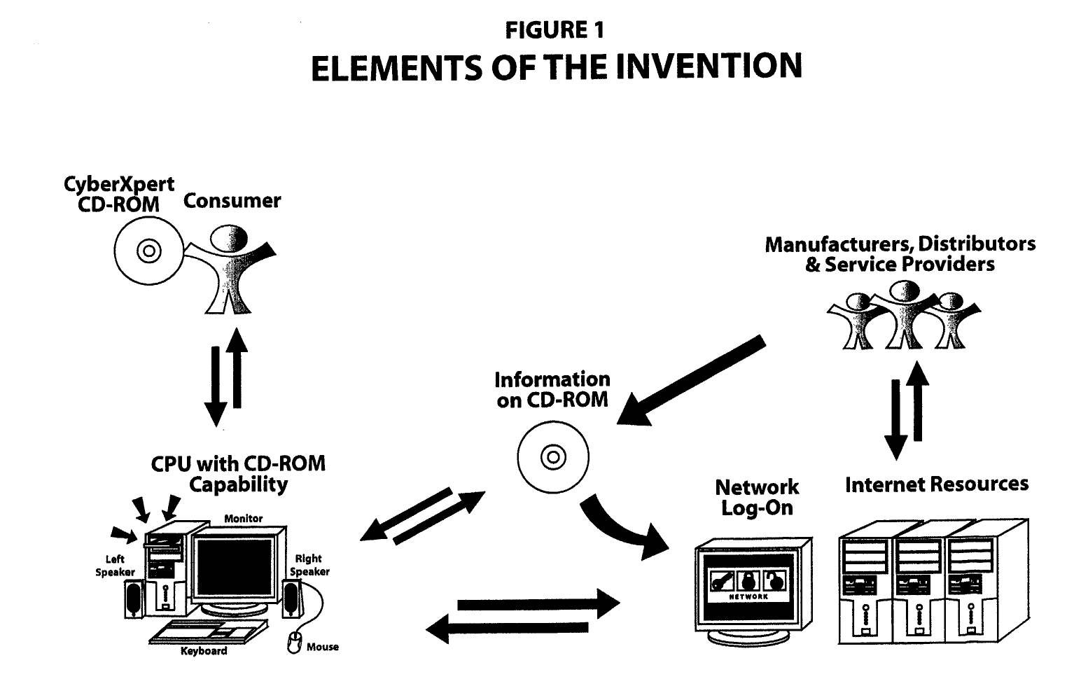

As shown by FIG. 1, the CyberXpert Companion Suite of Products is distributed on a CD-ROM, a portable mass data storage medium. In addition, this invention is being adapted to the World Wide Web; online subscriptions will then be available to customers.

This invention serves multiple key audiences via an entirely new concept in marketing and E-commerce that Technologists, Inc. (TI) is calling the “business to business to business single-product concept” (B2B2B). B2B2B is a unique combination creating a synergy where the total information and utility result in benefits for each entity. This unique process offers multiple cross-cutting benefits. Manufacturers, distributors and service providers are able to routinely update pertinent information as necessary. By ensuring that the information is never out of date, the customer benefits by saving both time and money. Further, the end user's knowledge of choices is greater than the sum of the parts. The end user is provided with real-life solutions, simpler navigation, greater access to information, an array of resources previously not integrated, and a variety of time-saving features. In short, the present invention reduces the time needed to make more informed decisions.

The development of the B2B2B single-product concept is based on the application of TI's simulated artificial intelligence model™ (SAIM). In brief, SAIM focuses on replicating the processes behind the acquiring, processing, storing, and using of information. By applying SAIM, the present invention is built on smart information design. The most relevant information is aggregated, qualified, and retained based on relevancy. Second, the look, feel, and utility of the present invention are governed by the principle of maximized productivity versus the construction of a filing cabinet for electronic documents. SAIM is also used to identify and overcome key barriers that must be mitigated for success, and it ensures the delivery of high-quality content targeted at specific customer groups. SAIM allows development of an effective tool that does the following:

Simplifies delivery of product and service information to customers.

Transforms information into applied knowledge.

Eliminates layers of peripheral information.

Makes it easy for customers to find information on desired products and services.

The B2B2B approach goes beyond the business-to-business (B2B) concept. Internet industry analysts (Hooversonline.com, Mar. 7, 2002) have reported that B2B has failed because many companies declined to participate fully and sufficiently. The most noted reason cited by businesses was the fear that they would be forced to compete on price alone. Though reluctant to participate, B2B providers are under increasing pressure from customers from various industries who are demanding that products and services be offered online for convenience purposes. The CyberXpert Companion Suite of Products is used to develop industry- and audience-specific tools that are the backbone of the B2B2B innovative business process. This innovative process resolves the asymmetrical interests of all parties involved in a mutually beneficial manner that provides a very specific and unique utility for each participant and potentially revitalizes the faltering B2B industry. Traditional retail and E-commerce distributors are not utilized in this unique process.

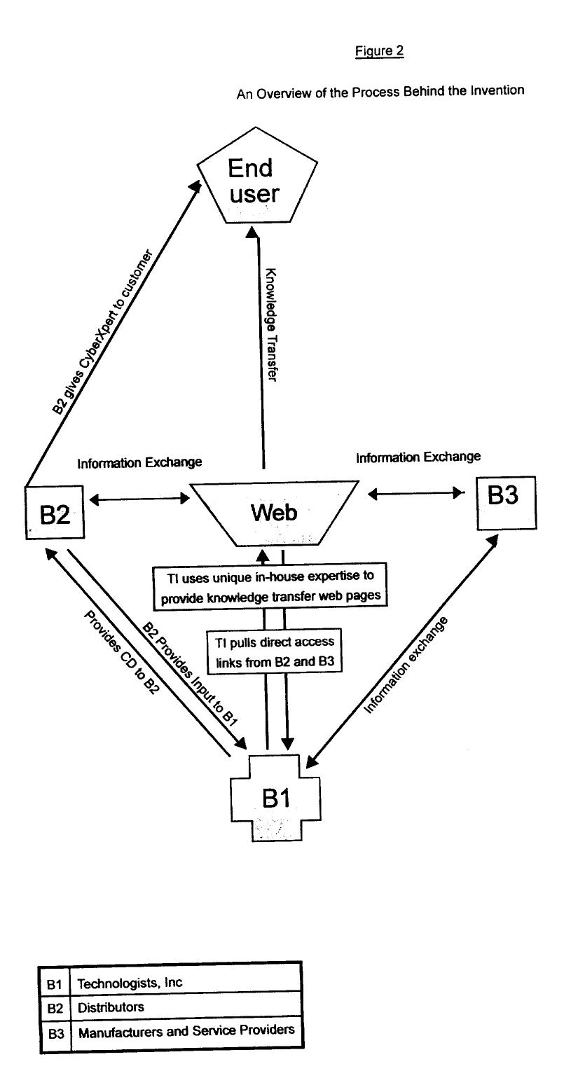

As illustrated by FIG. 2, Technologists (B1) tailors a specific product from the CyberXpert Companion Suite of Products to deliver a knowledge-based tool to the strategic distributor (B2) (i.e., a lender, broker, or financial services provider) for distribution. This product is a cost-effective, credible, “thank you for your business” gift or market farming tool with a long shelf life. It also contains a commercial with links to the distributor's Web site for further service. It becomes a lead-generating, repeat business, continual exposure tool, as well as a useful tool for the end user.

The distributed tool provides content to the end user that specifically addresses typical decisions the customer will face after the transaction is complete. These include, but are not limited to, supporting purchasing decisions, time- and energy-saving actions, maintenance, and environmental concerns. The content has been prepared and researched by B1 and contains more than 300 links to tailored Web pages, government resources, and printable coupons that B1 has obtained from B2. Links to the Web sites and tailoring of tactical messaging about B2 products is also embedded and strategically positioned to facilitate instant comprehension about the value of the suggested product in a factual and dynamic manner substantiated by expert content development. Strategic positioning and tactical knowledge-driven messaging is based on performance, convenience, and conservation. Price positioning and competition is avoided except through the printable coupon, which is offered via a closed private Web site for end users who have been given the CD-ROM or Web site code from B1. Coupons can be updated in real time.

The tool contains links to the Internet and significant knowledge to help the end user make better, more informed choices. B2 is better served than through mass distribution to users separated by demographic distinctions because, in most cases, the end user is ready to buy. Also, the product goes with the end users when they move and therefore has a longer impact than a direct mail or statically delivered item. Volume pricing is available and pursued, and drop-shipping and pick-and-pack fulfillment are offered to smaller branch offices.

The unique utility for B1 is in the highly adaptable, integrated design that maximizes market penetration and segmentation in a single product that can and will be continuously improved as additional customers are secured. Although B2 benefits from the high-quality content, design, and brand customization opportunities, the most unique utility is that the contributions of one B1, B2, or B3 will assist another B2 in securing business and closing deals. One of the financing options provided by B1 and B2, for example, informs the customers that they may qualify for a larger mortgage if they choose energy-efficient appliances. Realtor distributors can use this tool to promote themselves and farm the market, and at the same time help clients get approved for this higher-value, energy-efficient mortgage. B3 benefits from the unique product positioning in this targeted market of customers who are, in many cases, ready to buy. They also benefit because the distributors' (B2) use of the tool creates a market push-and-pull effect for this captive audience.

In the preferred embodiment, the CyberXpert Companion Suite of Products provides a tool intended to satisfy the information needs of individual customers. This invention is a seamlessly integrated tool that relies on both CD-ROM and World Wide Web-based capabilities. In addition, this invention is being adapted to the World Wide Web for sponsoring by or licensing to B2; online subscriptions will then be available to customers.

The tool transfers knowledge, influences behavior, and affects customer product selection, operation, maintenance, and financing. This tool integrates information into a package emphasizing a home's interior and exterior features. This tool integrates the information needed to simultaneously create awareness, interest, desire, and action into a single source focused on product selection, operation, and maintenance. A unique product rating system helps customers choose products based on performance, convenience, and resource conservation. Its interactive, game-like design combines multiple features aimed at multiple audiences.

In a preferred embodiment, the tool provides customers with information tailored to assist and enhance purchasing decisions. Most of the goods and services are standard. The tool uses an effective, interactive medium for connectivity between buyers and sellers. Integrating CD-ROM and Web-based capabilities provides a practical and useful approach to transferring knowledge. The invention is based on the premise that delivering clear information is essential so that the customer is able to reach a decision. This includes radically expanding the base of information. The invention connects individual information resources so that a customer can reach a decision in the shortest possible time.

This invention is designed in part to respect the following premise: the greater the span of communication given to customers, the greater their span of influence. The greater their span of influence, the more power the customer will be. When the span of information is limited, the influence the customer can bring to bear is minimal, change is minimal, and benefits to all parties are minimal. By expanding the ability of the individual customer, the invention expands the visibility of sound solutions to customer situations. Expanding the visibility of solutions takes the customer beyond the static limits of catalogues to real-time information from a variety of sources.

One purpose of the invention is to allow customers who cannot or do not want to visit commercial establishments to gather product-related information critical to a purchasing decision. The present invention allows, for example, pre-shopping of an appliance or service from one's home, office, or other location equipped with a personal computer that has Internet access capability. Relevant information can be searched, collected, and analyzed, thereby reducing shopping time.

It is anticipated that the preferred embodiment of the present invention will be a commercial product sold under the trade name CyberXpert Companion Suite of Products. This invention is distributed on a CD-ROM, a portable mass data storage medium, and is either sold to customers or distributed free of charge. The portable mass data storage medium is characterized by its ability to record large volumes of data. Further, it is removable from its corresponding reader. Portable mass storage tools are intended for distribution to customers because these items represent a cost-effective means of transmitting information to customers. In the preferred embodiment of the present invention, the portable mass data storage means is CD-ROM, but other means may be suitable as well. The CD-ROM is intended for personal use at the customer's home, office, or other location equipped with a personal computer that has Internet access capability.

To use this product, the customer needs a personal computer equipped, at a minimum, with one of the following operating systems: Windows 95, 98, ME, NT, 2000, or XP. If the customer has a Macintosh (Mac) computer, the minimum operating system is Mac OS 9. The computer must be equipped with a modem for Internet connectivity, a mouse, and a monitor. For a PC, the recommended system is an Intel Pentium 400+; for a Mac, the recommended system is a G3+. The machine should be equipped with 64 megabytes of memory. The display should be 800×600 resolution and 16-bit color. A 16-bit (or greater) sound card is also recommended. Notebook computers of similar configuration can also use the product. The program is initiated by installing the CD-ROM into the PC's disk drive. Once initiated, the monitor display will show the product's opening screen. As outlined in FIG. 2, the customer is prompted to proceed to the specific area of interest. By following the prompts, the customer can access information stored on the CD-ROM and, if desired, access information resources on the World Wide Web.

The present invention helps overcome typical structural barriers of hierarchical organizations by focusing on the needs of the customer. The present invention increases the ability of the individual customer to gather and understand pertinent information about desired products and services. The present invention increases the customer's span of influence by connecting individual information resources together, allowing the customer to reduce the time needed to make an informed decision. Further, increasing reliance on electronic media demands that manufacturers, distributors, and service providers adopt customer-friendly approaches to sharing information. The present invention provides manufacturers, distributors, and service providers with a customer-friendly approach to providing solid information tied to rapid response.

Although the present invention has been described for purposes of illustration, it is understood that variations can be made by those skilled in the art without departing from the scope of the invention. The preceding descriptions of the functioning of the present invention are to be considered illustrative. In various embodiments of the present invention, operational steps may be added, eliminated, or modified.

The process and apparatus of the present invention is defined by the following claims:

1. The present invention, the CyberXpert Companion Suite of Products, is claimed to be a novel, stand-alone tool based on an entirely new concept in marketing and E-commerce that is being called the “business to business to business single-product concept” (B2B2B).

2. The invention, as claimed in claim 1, creates a unique synergy that benefits multiple parties by integrating traditional advertising and new media outlets with purposeful dynamics that strategically position multiple products' features and benefits in the hands of potential and existing customers when they are poised to act.

3. The invention, as claimed in claim 1, relies on knowledge-based, story-like content and the simulated artificial intelligence model™, which facilitates rapid comprehension about the value of a product or service when the consumer needs or wants it.

4. The invention, as claimed in claim 1, is an effective tool that does the following:
Simplifies delivery of product and service information to customers.
Transforms information into applied knowledge.
Eliminates layers of peripheral information.

5. The invention, as claimed in claim 1, provides the customer with a large volume of product- and service-related data recorded on a CD-ROM, a portable mass data storage device.

6. The information found within the invention, as claimed in claim 1, is accessed by the customer by using a personal computer equipped with a CD-ROM drive and a modem for Internet connectivity.

7. The invention, as claimed in claim 1, uses a CD-ROM with a data retrieval speed amenable to real-time presentation of product- and service-related data.

8. The invention, as claimed in claim 1, relies on a three-click strategy that ensures that the customer is never more than three clicks away from the desired information.

9. The invention, as claimed in claim 1, is based on a highly adaptable, integrated design that maximizes market penetration and segmentation into a single product that will be modified and improved continually to satisfy the needs of manufacturers, distributors, and service providers.

10. The invention, as claimed in claim 1, provides rapid access via QuickClicks™ to the specific item through information found on the CD-ROM or on a manufacturer's, distributor's, or service provider's Web site.

11. The invention, as claimed in claim 1, can be used by the customer to access additional resources about products and services by providing deep links to specific locations on the World Wide Web.

12. The invention, as claimed in claim 1, works with the World Wide Web to access Internet-based information servers that contain product-related information resources.

13. The invention, as claimed in claim 1, provides multiple benefits to manufacturers, distributors, and service providers, including the following:
These entities are able to incorporate their logos and branding into the packaging, introduction, and QuickClicks™ feature for a customizable gift, advertisement, and business-generation tool to a targeted customer base.
These entities are able to edit content to tailor the invention to promote their specific products, brands, or services.
These entities are able to purchase or sponsor deep links, driving customers to their World Wide Web sites.
These entities are able to utilize the printable coupon feature for promotional purposes.
These entities are able to purchase customizable packaging and front-end logo integration.
By embedding tactical messaging, customizable knowledge gazette supplements emphasize key messages for specific products and services.
Entities benefit from continuous distribution and delivery of strategically selected and placed links and coupons to current and potential customers, which facilitates customer understanding of a product or service and drives buying decisions.
Personalized commercials at the opening and closing of the CD-ROM communicate directly with customers.
The robust integration of products and services ensures continuous use and a long shelf life with customers, which provides repeated message reinforcement, customer retention, and repeat business.

14. Based on its high-quality content, design, and brand customization opportunities, the invention, as claimed in claim 1, will support manufacturers, distributors, and service providers in securing business and closing deals.

15. The invention, as claimed in claim 1, can be used for promotional purposes and marketing, while helping customers make informed choices about a wide variety of customer products.

16. The invention, as claimed in claim 1, provides clear benefits through unique customer product positioning in this targeted market of customers who are, in many cases, ready to buy.

17. The invention, as claimed in claim 1, creates a market push-and-pull effect to a captive audience.

18. The invention, as claimed in claim 1, provides a range of information about customer products to multiple audiences based on the qualities of benefits to each audience.

19. The invention, as claimed in claim 1, provides an independent assessment of a variety of customer products based on multiple elements and tailored to customer needs.

20. The invention, as claimed in claim 1, provides a Savings Rating tailored to reflect the benefits of individual products, such as a product's ability to save money or energy.

21. The invention, as claimed in claim 1, creates a summary of customer product-related options based on multiple elements and tailored to customer needs.

22. The invention, as claimed in claim 1, requests and stores customer product-related information relevant to the needs of different customers.
